(19) United States
(12) Patent Application Publication
(10) Pub. No.: US 2022/0297495 A1
(43) Pub. Date: Sep. 22, 2022

(54) SUSPENSION SYSTEM WITH JUMP CONTROL AND/OR WHOOP DETECTION

(71) Applicant: Ford Global Technologies, LLC, Dearborn, MI (US)

(72) Inventors: Tom Sawarynski, Dearborn, MI (US); Jason Michener, Novi, MI (US); Chris Michael Paiva, Novi, MI (US); Ali Abdallah, Dearborn, MI (US); Timothy Panagis, Ypsilanti, MI (US); Andy Robert Vrenko, Ypsilanti, MI (US); Adam Stroup, Belleville, MI (US)

(21) Appl. No.: 17/202,682

(22) Filed: Mar. 16, 2021

(51) Int. Cl. B60G 17/0165; B60G 17/015; B60G 17/018; B60G 17/019

(52) U.S. Cl. CPC B60G 17/0165; B60G 17/0157; B60G 17/018; B60G 17/019; B60G 2400/204; B60G 2400/252; B60G 2400/208; B60G 2400/821; B60G 2500/10; B60G 2600/1877; B60G 2600/26

(57) ABSTRACT

A method of automatically applying damping force interventions for a suspension system of a vehicle may include receiving ride height information from a plurality of ride height sensors associated with respective individual wheels of the vehicle, and receiving vehicle speed information. The method further includes determining, based on the ride height information, vehicle speed and timing information, whether a trigger event has occurred. The method also includes generating damping intervention signals to selected ones of the respective individual wheels of the vehicle responsive to determining that the trigger event has occurred.

### TECHNICAL FIELD

Example embodiments generally relate to vehicle suspension and, more particularly, relate to an electronically controlled suspension system that is capable of improving stability for driving in environments with repetitive undulations or where a jump is detected.

### BACKGROUND

Vehicles commonly employ a solid axle or an independent suspension that allows each wheel to move relative to the vehicle chassis independent of the other wheels. The components and geometries used for these suspension designs can vary to some degree. Within some suspension systems, shock absorbers (or simply “shocks”) are provided, which are designed to provide damping for pitch (i.e., oscillation about a lateral axis of the vehicle). The shocks generally resist compression and rebound with damping forces that are applied over a range of travel of a piston rod.

Once a typical vehicle is designed and the damping components have been selected, the components operate to provide the damping for which they are designed. However, the selected damping components will have certain limits to the amount of maximum travel that the damping components can permit before reaching a limit in either the compression or rebound direction. When the limits are reached, a hard stop may be encountered. For environments with repeated undulations (referred to as “whoops”), or for situations where wheel contact with the ground is lost (i.e., a jump), reaching the hard stop may result in a very rough ride and a harsh landing or (in the other direction) loss of wheel contact with the ground. Either of these situations may detract from the driver's enjoyment of the driving experience.

### BRIEF SUMMARY OF SOME EXAMPLES

In accordance with an example embodiment, a vehicle control system for improving suspension performance of a vehicle may be provided. The vehicle control system may include a plurality of ride height sensors that determine ride height information associated with individual wheels of a vehicle, a plurality of adjustable dampers associated with respective ones of the individual wheels of the vehicle, and a controller that detects a trigger event and generates damping intervention signals to change damping force applied by selected ones of the adjustable dampers based on vehicle speed, the ride height information, and timing information corresponding to the selected ones of the adjustable dampers in response to detecting the trigger event.

In another example embodiment, a method of automatically applying damping force interventions for a suspension system of a vehicle may be provided. The method may include receiving ride height information from a plurality of ride height sensors associated with respective individual wheels of the vehicle, and receiving vehicle speed information. The method further includes determining, based on the ride height information, vehicle speed and timing information, whether a trigger event has occurred. The method also includes generating damping intervention signals to selected ones of the respective individual wheels of the vehicle responsive to determining that the trigger event has occurred.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a perspective view of a vehicle encountering undulating terrain and certain components of a suspension system of the vehicle in accordance with an example embodiment;

FIG. 2 illustrates a block diagram of a suspension control system in accordance with an example embodiment;

FIG. 3 illustrates a block diagram showing modules or sub-modules associated with a controller of the system of FIG. 2 in greater detail in accordance with an example embodiment;

FIG. 4 illustrates a diagram of wheel position determination in accordance with an example embodiment;

FIG. 5 illustrates an example of force adjustment for a jump event in accordance with an example embodiment;

FIG. 6 illustrates an example of force adjustment for driving over whoops in accordance with an example embodiment;

FIG. 7 illustrates a control flow diagram showing suspension control in accordance with an example embodiment; and

FIG. 8 is a block diagram of a method of improving vehicle suspension according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Repetitive sets of relatively large undulations (sometimes referred to as “whoops”) can cyclically put shock absorbers or dampers into the ranges in which large loads can be transferred to the vehicle chassis. This can lead to a harsh and unpleasant ride for drivers and passengers, and may sometimes lead to vehicle damage or loss of wheel contact with the ground. In this regard, when a vehicle encounters large displacement bumps of between about 1-3 feet in height one after another (i.e., whoops), vehicles with too little shock damping will allow over-travel of the suspension, and the harsh results described above. Meanwhile, if the vehicle has too much shock damping, the body of the vehicle may pitch excessively and wheels may lose contact with the ground.

Operators will tend respond to any of the experiences noted above by manually reducing speed dramatically until the effects cannot be felt. However, this may correspondingly reduce the enjoyment that many operators may otherwise get from off-road driving. Accordingly, it may be desirable to provide a system that is capable of detecting whoops or jumps, and proactively reacting to such detections to adjust compression and rebound damping to improve the vehicle's response and the operator's experience. For example, some example embodiments may provide for an increase in compression damping when a jump event is detected to prevent a harsh landing. Some example embodiments may alternatively or additionally increase rebound damping to reduce after bounce. Example embodiments may also provide sub maximal compression damping to stop the vehicle body from getting pushed around in whoops and provide less rebound damping to allow the wheels to stay in contact with the ground, even at relatively higher speeds. Some example embodiments described herein may provide an improved suspension system that employs a control system that is capable of automatically taking action to improve ride quality and contact between the wheels and the ground even the most challenging of contexts, such as riding over whoops. As a result, vehicle performance and driver satisfaction may also be improved.

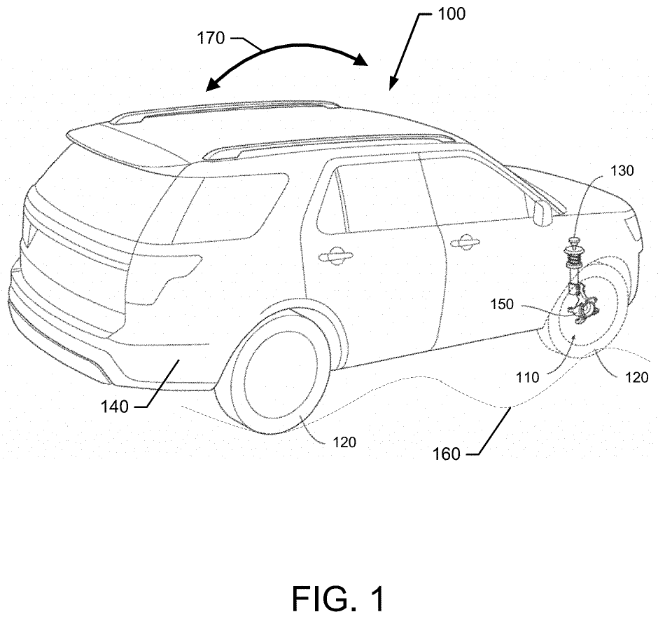

FIG. 1 illustrates a perspective of a vehicle 100 employing a suspension system 110 of an example embodiment. The suspension system 110 includes a plurality of wheels 120 in contact with the ground, and a damper 130 (e.g., a shock absorber or shock) disposed between each one of the wheels 120 and a body 140 or chassis of the vehicle 100. In some cases, the wheel 120 may be operably coupled to the damper 130 via a steering knuckle 150. Additional links may also be provided between the chassis and the steering knuckle 150 to stabilize the wheel 120, but such links are outside the scope of example embodiments.

As shown in FIG. 1, undulating terrain 160 (or whoops) that is repetitive in nature may be encountered by the vehicle 100. The body 140 of the vehicle 100 may tend to move up and down pitching cyclically as shown by double arrow 170 as the undulating terrain 160 is traversed. The pitching may correspondingly cause cyclic compression and extension of the damper 130 of the suspension system 110, as the damper 130 attempts to dampen out the motion. Because the damper 130 necessarily has a limited amount of linear travel for the piston rod therein, a certain degree of harshness could be encountered when the limit is reached at either end. To reduce this harshness, and provide a smoother ride for passengers, the damper 130 may provide additional damping force (e.g., additional hydraulic force) near the respective limits. The provision of the additional damping force may be controlled responsive to detection of specific conditions that correspond to travel over whoops, or even responsive to detection of individual jump events.

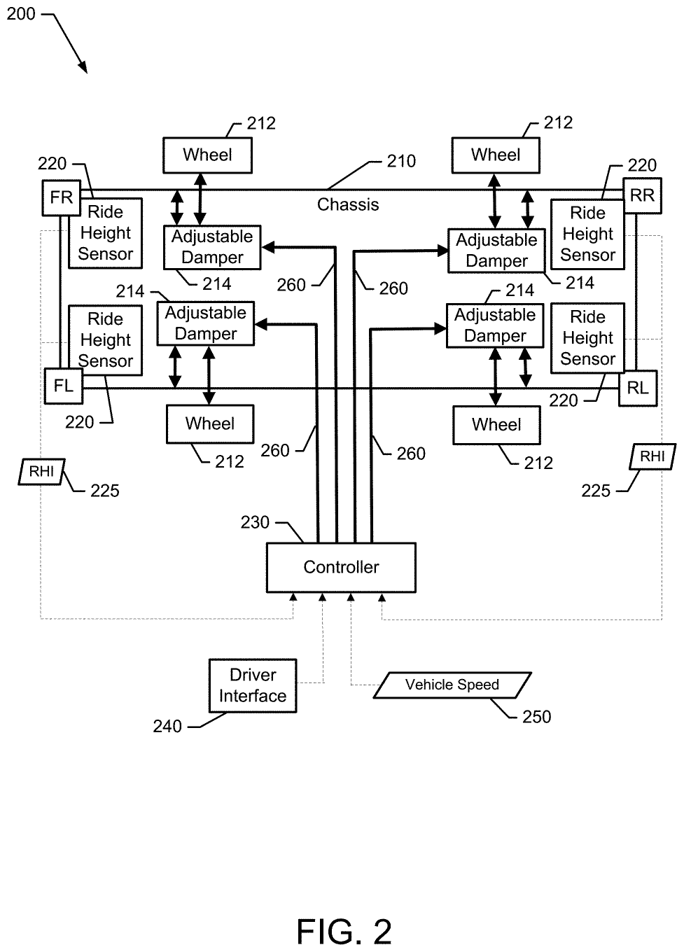

To improve suspension performance, example embodiments may employ a suspension control system 200. The suspension control system 200 may be configured to detect jump events or travel over whoops and intelligently control damping force augmentation to improve suspension performance. An example is shown in FIG. 2, which illustrates a block diagram of the suspension control system 200. As shown in FIG. 2, a vehicle chassis 210 may be provided with wheels 212. The wheels 212, and corresponding instances of an adjustable damper 214 for each respective one of the wheels 212 may form part of a suspension system of the vehicle on which the suspension control system 200 is deployed.

In an example embodiment, the suspension control system 200 may include a ride height sensor 220 associated with each wheel 212 and each respective adjustable damper 214. In this regard, an instance of the ride height sensor 220 may be provided in or near each corner of the chassis 210 (e.g., front-right (FR), front-left (FL), rear-right (RR) and rear-left (RL)). The ride height sensors 220 may be configured to determine a height of the chassis 210 (or another reference point on the vehicle) relative to the ground or a reference location that is generally assumed to correspond to the ground. The ride height sensors 220 may be embodied in any of a number of different ways including via analog impedance sensors or the use of lasers or other optical sensing means. However, any suitable ride height sensor could be employed.

The ride height sensors 220 may be operably coupled to a controller 230, which may be an electronic control unit (ECU) of the vehicle, or a separate instance of processing circuitry comprising a processor and memory. The controller 230 may be configured (e.g., via hardware, software or a combination of hardware and software configuration or programming) to receive ride height information (RHI) 225 from the ride height sensors 220 (and sometimes also from other components) and strategically apply damping adjustments to individual ones of the adjustable dampers 214 as described in greater detail below.

Thus, for example, the controller 230 may also be operably coupled to a user interface (e.g., driver interface 240), and may receive information indicative of vehicle speed 250. In an example embodiment, the controller 230 may be configured to generate damping intervention signals 260 to change the damping characteristics of individual ones of the adjustable dampers 214 during vehicle pitch based on encountering whoops or even jumps. The damping intervention signals 260 may be generated based on the vehicle speed 250 and the ride height information (RHI) 225 generated by the ride height sensors 220 responsive to such information being used by the controller 230 to detect (and in some cases also classify or characterize) a jump event and/or encountering whoops.

Although not required, in some examples, the interventions generated by the controller 230 may be generated in a particular, driver-selected operational mode. Thus, for example, the driver interface 240 may be used by the driver to enter a mode in which the controller 230 is enabled to detect jump events or driving over whoops, and further enabled to generate the damping intervention signals 260 responsive to detection of either the jump events or the existence of whoops. In some cases, the driver interface 240 may be provided at the steering wheel, dashboard, center console, armrest or any other console or location conveniently accessible to the driver. The driver interface 240 may include a button, switch, lever, key (soft or hard) or other operable member that can be actuated to activate the controller 240 into the driver-selected operational mode in which damping intervention signals 260 are generated. When the driver-selected operational mode is activated, the controller 230 may be enabled to automatically monitor conditions to determine whether (and when) to apply the damping intervention signals 260 as described herein. However, as an alternative, the controller 230 may be configured to generate the damping intervention signals 260 without selection or knowledge of the driver. In other words, the controller 230 may be configured to run autonomously in the background in some cases.

In an example embodiment, the controller 230 may operate to generate the damping intervention signals 260 responsive to one or more triggers or initiating events. Although many different triggers or initiating events could activate the controller 230 to cause the damping intervention signals 260 to be generated, some example embodiments may provide that at least one such trigger or initiating event is receipt of ride height information 225 indicating a wheel position consistent with a jump, or receipt of ride height information 225 indicating a change in wheel position that is indicative of riding over whoops. Changes in wheel position that indicate driving over whoops may include repetitive or cyclic transitions between rebound and jounce (or compression). Thus, the controller 230 may be configured to detect an instantaneous event (such as a jump event) and to detect situations that require evaluation of data received over time (e.g., durative events) to detect repetitive or cyclic conditions that are not instantaneous. Whether responding to a durative event or an instantaneous event, the controller 230 may generate the damping intervention signals 260 to alter the damping characteristics of the adjustable damper 214 to improve the ability of the vehicle to traverse the terrain more smoothly to improve the driving experience, and maintain contact of the wheels 212 with the terrain.

In an example embodiment, the controller 230 may be configured to execute a damper control algorithm stored at or accessible to the controller 230. In this regard, for example, the controller 230 may be configured to receive the ride height information 225 from each of the ride height sensors 220 along with vehicle speed 250 and execute the damper control algorithm based on such information. The damper control algorithm may configure the controller 230 to determine whether and when to apply the damping intervention signals 260 (on a wheel-by-wheel basis). In other words, the damper control algorithm may include programming for determining, in real time or near real time, the conditions at each respective one of the wheels 212 in the context of the overall situation of the vehicle, and provide damper control inputs in the form of damping intervention signals 260 to the individual respective ones of the wheels 212 in order to maximize stability with respect to avoidance of situations where limits of wheel travel are reached and rough impacts are therefore transmitted to the chassis 210. As such, the damping intervention signals 260 provided by the controller 230 may indicate which individual one of the wheels 212 is to have modified damping forces applied thereto by the respective instance of the adjustable damper 214 that correspond to the individual one of the wheels 212. Moreover, each of these individual controls for the wheels 212 may be received simultaneously and may be the same or different from the controls prescribed for other wheels 212.

Based on the ride height information 225, vehicle speed 250 and information about the wheel structure (e.g., distance between front and rear wheels), the controller 230 may also be configured to make predictions regarding when rear wheels will encounter situations already encountered by the front wheels. Thus, jounce or rebound positions may be anticipatorily accounted for to reduce or minimize any amount of time that a corresponding wheel may otherwise not be in contact with the road, or mitigate harsh landings. Thus, for example, the controller 230 may perform a damping intervention based on a prediction regarding when rear wheels will encounter a situation already encountered by front wheels.

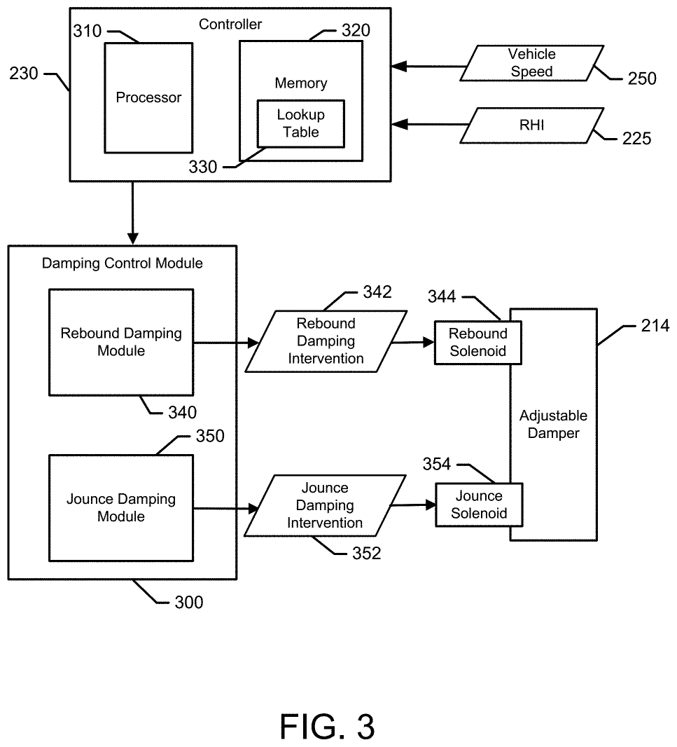

Referring now to FIG. 3, operation of the controller 230 and the interactions the controller 230 has with the adjustable damper 214 (or at least one instance thereof) will be described in greater detail. As such, FIG. 3 illustrates a block diagram of various components of the suspension control system 200 in greater detail. In this regard, for example, FIG. 3 illustrates example interactions between the controller 230 and a damping control module 300, which may be instantiated at the controller 230 to generate the damping intervention signals 260. As such, for example, the damping control module 300 may be a portion of the controller 230 that is programmed or otherwise configured to generate the damping intervention signals 260 under the control of the controller 230 (e.g., based on the execution of one or more control algorithms). Processing circuitry (e.g., a processor 310 and memory 320) at the controller 230 may process the information received (e.g., vehicle speed 250 and ride height information 225) by running one or more control algorithms that cause the functioning of the damping control module 300. The control algorithms may include instructions that can be stored by the memory 320 for retrieval and execution by the processor 310. In some cases, the memory 320 may further store one or more tables (e.g., look up tables 330) and various calculations and/or applications may be executed using information in the tables and/or the information as described herein.

The processor 310 may be configured to execute the control algorithms in series or in parallel. However, in an example embodiment, the processor 310 may be configured to execute multiple control algorithms in parallel (e.g., simultaneously) and substantially in real time. The control algorithms may be configured to perform various calculations based on the information received/generated regarding specific conditions of vehicle components, and particularly conditions related to detecting jump events or the existence of whoops. The control algorithms may therefore execute various functions based on the information received, and generate outputs to drive the control of the damping intervention signals 260 applied to the adjustable dampers 214 associated with each of the wheels 212 of the vehicle.

The damping control module 300 may itself be a control algorithm, or may include control algorithms in the form of functional modules (or sub-modules) configured to perform specific functions for which they are configured relating to control of the vehicle suspension in the manner described herein. Thus, for example, the controller 230 may actually function as the damping control module 300 responsive to executing the control algorithms. However, in other cases, the damping control module 300 may be a component or module of the controller 230, or an entirely separate component (e.g., possibly also including its own corresponding processing circuitry). Although not required to be separated, in some cases, the damping control module 300 may separately handle rebound and jounce with corresponding individual modules or sub-modules dedicated to each respective situation. Thus, for example, the damping control module 300 may further include a rebound damping control module 340 that issues rebound damping interventions 342 to a rebound solenoid 344 disposed at the adjustable damper 214. The damping control module 300 may also include a jounce damping control module 350 that issues jounce damping interventions 352 to a jounce solenoid 354 disposed at the adjustable damper 214. The rebound damping intervention 342 and the jounce damping intervention 352 are each examples of the damping intervention signals 260 described above.

As noted above, the information upon which the control algorithms operate may include a wheel position for each wheel 212 (as determined by the ride height information 225) and vehicle speed 250. The vehicle speed 250 may be provided from a speedometer of the vehicle, from global positioning system (GPS) information, or any other suitable source including detectors capable of measuring wheel speed for each individual one of the wheels 212 of the vehicle. Time may also be an important consideration for the controller 230 (or for the damping control module 300) in relation to generating of either or both of the rebound damping interventions 342 and the jounce damping interventions 352. In this regard, for a jump event, the amount of time that a jump occurs (e.g., the amount of time that one of the wheels 212 is not in contact with the ground) may be indicative of the amount of impact that can be expected when the wheel 212 contacts the ground. Similarly, for a situation where whoops are encountered, the timing of the cyclic change from compression to rebound is helpful in determining when the next cycle of compression or rebound should be expected, and therefore also to what degree anticipatory damping adjustments can be made to mitigate the cyclic compression and rebound events.

The lookup table 330 may, for example, include speed values and ride height values for each of the wheels 212, along with timing information, and corresponding indications of whether to apply damping interventions and perhaps also how much damping intervention to apply (e.g., via the damping intervention signals 260). In some cases, the lookup table 330 may also include wheel velocity (e.g., especially for rebound force determinations). Thus, for example, the lookup table 330 may be entered based on the ride height information 225, time information, wheel velocity and/or the vehicle speed 250 to determine whether and when to generate the damping intervention signals 260 (and for which wheel(s) 212). Various combinations of any of the parameters or values included in the lookup table 330 may be selectively employed based on the specific situation encountered to generate force requests. Thus, for example, the lookup table 330 may list force values in tabular form based on tables that include various ones of the values noted above to enter the table. The situation encountered may be determined based on changes from compression to rebound, proximity to max compression or rebound, reaching max compression or rebound, leaving max compression or rebound, or various other indications. Additionally or alternatively, a damping intervention to wheel position map may be constructed and used to map specific rebound damping interventions 342 or jounce damping interventions 352 to different wheel positions for corresponding different vehicle speeds 250 or time information. Wheel velocity (i.e., the speed at which the wheel position is changing) may also be used as a trigger or otherwise influence decisions associated with determining when to apply damping force along with how much and what type (rebound or compression) of damping forces to apply.

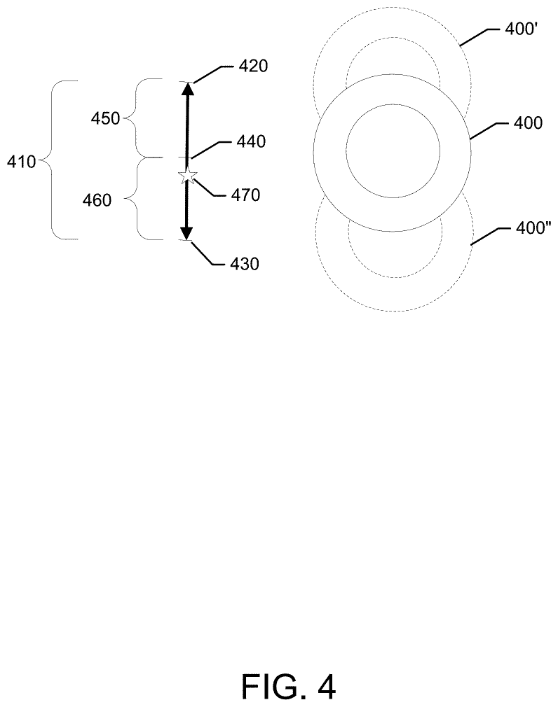

In some embodiments, as noted above, timing information, vehicle speed 250 and/or ride height information 225 may be used to enter the lookup table 330, or otherwise be used as the basis by which the controller 230 determines whether to generate the damping intervention signals 260 (and for what wheels 212). However, in some examples, the ride height information 225 may include, or be used to calculate or determine, certain other information that may be used as a basis for activity by the controller 230. For example, the ride height information 225 may include an indication of wheel position of a corresponding one of the individual wheels 212 relative to a range of travel of the wheel 212. In this regard, for example, FIG. 4 illustrates, in solid lines, a wheel 400 at a normal ride height. The same wheel at a positon of full compression 400′ and at a position of full rebound 400″ is also shown in dashed lines. Thus, a range of wheel travel 410 may be defined from max compression 420 to max rebound 430. A motion transition point 440 may also be defined to distinguish between a compression zone 450 (where the suspension system and damper (e.g., adjustable damper 214) of the wheel 400 is in compression) and a rebound zone 460 (where the suspension system and damper of the wheel 400 is in rebound). The ride height information 225 may therefore show (instantaneously) the current ride height of the vehicle or the current wheel position 470 of the wheel 400 relative to the range of wheel travel 410. In other words, the ride height information 225 may indicate to the controller 230 exactly where each wheel currently is within its own range of motion and possible locations at any instant in time. The controller 230 may then be configured to generate the damping intervention signals 260 at strategic times (or locations) within either a compression cycle, a rebound cycle, or based on proximity of the current wheel position 470 to the max compression 420 or max rebound 430 locations. As noted above, timing information may also be included. Thus, for example, if a jump event occurs, the wheel 400 may be expected to reach the position of full rebound 400″ when the wheel 400 leaves the ground. The amount of time the wheel 400 is at the full rebound 400″ position may indicate the magnitude of the jump (and corresponding expected magnitude of forces that would be encountered on landing). By using the timing information, the controller 230 may have a unique ability to understand where each wheel is in relation to the ground for a jump event, and adjust the damping to account for the detected jump event by increasing damping forces for compression (responsive to detecting hang time) and for rebound in anticipation of rebound after full compression is reached. Moreover, the increase in compression damping forces may build as time in the air builds. As such, the controller 230 not only responds to the jump event itself with force adjustments, but actually tailors the force adjustment to the magnitude of the jump event.

Timing may also be useful for a detection of whoops in that the timing between compression and rebound cycles may be quickly recognized as a whoop section and damping adjustments may be made both in real time responsive to the degree of rebound and compression experienced, but also preemptively for the rear wheels based on what is already encountered at the front wheels, and for all wheels based on repetitive cyclic information indicating the nature of the whoops themselves (e.g. relating to the distance between peaks and valleys and/or the height of the peaks and valleys of the whoops).

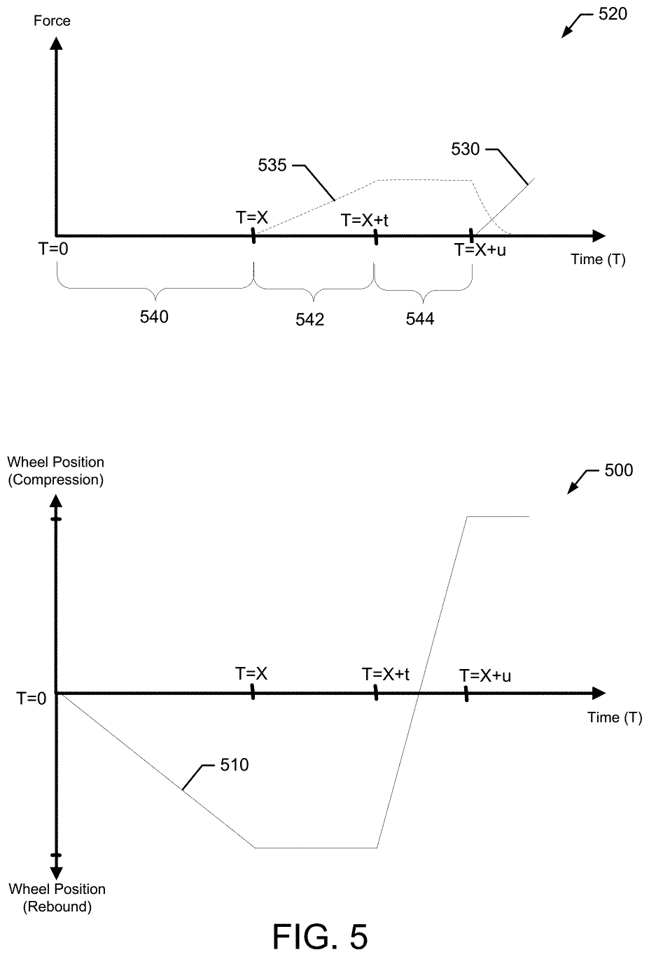

FIG. 5 illustrates an example of force adjustment (specifically for the jounce damping signal 352) for a jump event. In this regard, FIG. 5 shows a wheel position vs. time plot 500 in which wheel position 510 is plotted. As can be seen from the wheel position vs. time plot 500, the wheel position 510 moves from the motion transition point 400 at time=0 to a position of maximum rebound at time=X. Thereafter, the wheel position 510 shows that the wheel remains at the position of maximum rebound for at least a time=t. FIG. 5 also shows a force vs. time plot 520 to indicate the results of the operation of the controller 230 as described above. In this regard, a rebound damping force curve 530 and a compression damping force curve 535 showing the amount of added force applied to the adjustable damper 214 to account for the wheel position 510 shown in the wheel position vs. time plot 500. In this regard, for a period 540 no additional force may be applied and the adjustable damper 214 may operate normally. However, for the period 542, which covers a period of time at which the wheel position 510 is at maximum rebound, compression damping force may be added as shown by the compression damping force curve 535.

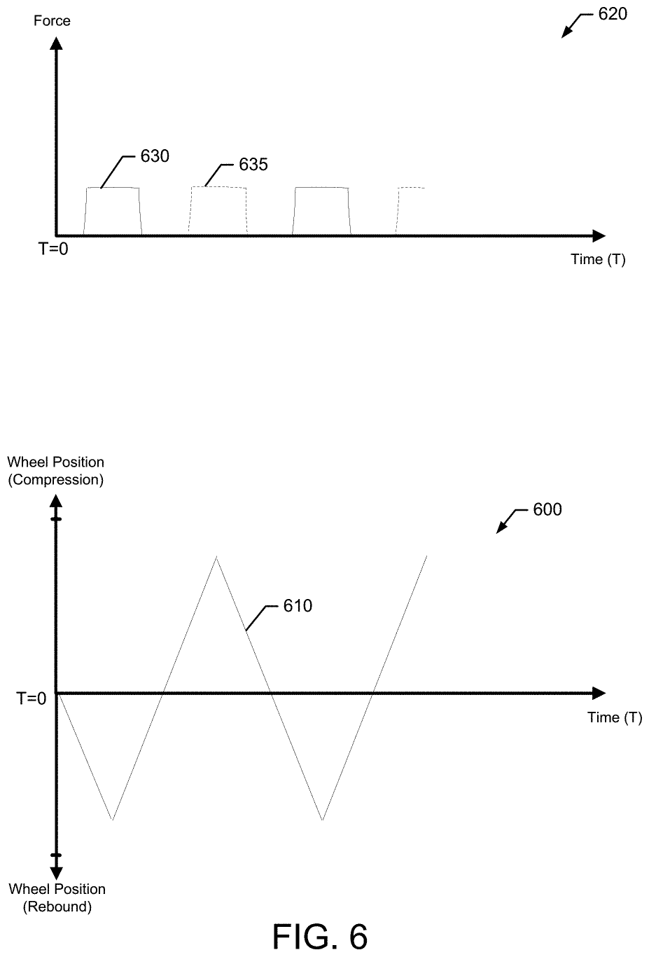

The increase in force shown by the compression damping force curve 535 in period 542 may be indicative of the controller 230 determining that the hang time is indicative of the amount of compression force that will be felt when the wheel hits the ground. Thus, the compression force may build proportional to the amount of hang time. The increase in force shown by the compression damping force curve 535 is anticipatory in that the controller 230 determines that significant amount of compression will result from the fact that the wheel is not in contact with the ground after time=X. Of note, rebound damping force curve 530 shows a linear increase in force over the period 542, but the increase could alternatively be non-linear, or a prompt jump. When (after time T=X+t) the wheel is no longer in maximum rebound, the compression damping forces have already been built up to receive the impact of landing. Meanwhile, the rebound damping force curve 530 may build in magnitude after the wheel reaches maximum compression (at time T=X+u) in anticipation of the potential for a return to rebound after the compression cycle. Accordingly, FIG. 5 shows real time responsive damping force changes (e.g., for one adjustable damper) in one direction (rebound), while anticipatory damping force changes are simultaneously made in the other direction (compression) by the controller 230. Thus, for example, both rebound and jounce solenoids 344 and 354 may be adjusted for the adjustable damper 214 to account for current conditions and expected future in order to ensure that damping forces can always be tailored to each scenario including in advance of the encountering of certain scenarios. As such, by using the adjustable damper 214, and particularly by having independent control of valves that adjust damping forces in each direction (e.g., via the rebound and jounce solenoids 344 and 354), the controller 230 may always remain a step ahead in not only initiating damping for certain jump events, but tailoring the amount of damping to the specific nature of the jump event. However, both real time responsive and anticipatory damping force changes can also be made in cases where whoops are encountered, and no wheel necessarily leaves the ground. FIG. 6 illustrates such an example.

In this regard, FIG. 6 shows a wheel position vs. time plot 600 in which wheel position 610 is plotted. As can be seen from the wheel position vs. time plot 600, the wheel position 610 moves cyclically from rebound to compression as a set of whoops is encountered. The controller 230 may be able to detect the whoops based on the analysis of the changing wheel position 610. Moreover, in some cases, the controller 230 may determine either or both of the period or frequency of the whoops and the magnitude of the wheel position change that is caused by the whoops.

FIG. 6 also shows a force vs. time plot 620 to indicate the results of the operation of the controller 230 as described above. In this regard, a rebound damping force curve 630 and a compression damping force curve 635 showing the amount of added force applied to the adjustable damper 214 to account for the wheel position 610 shown in the wheel position vs. time plot 600. In this example, both the rebound damping force curve 630 and the compression damping force curve 635 end up being cyclic since the wheel position 610 shows cyclic changes as well. Notably, however, the shape and magnitude of the rebound damping force curve 630 and the compression damping force curve 635 may depend on the programming (e.g., the lookup table 330 values or mappings) of the controller 230. Moreover, in some cases, the speed of the vehicle may modify the shape and magnitude of the curves. In this regard, for example, curves may be accentuated or magnified for higher speeds. Thus, for example, a gain factor or multiplication factor may be employed for increasing speeds.

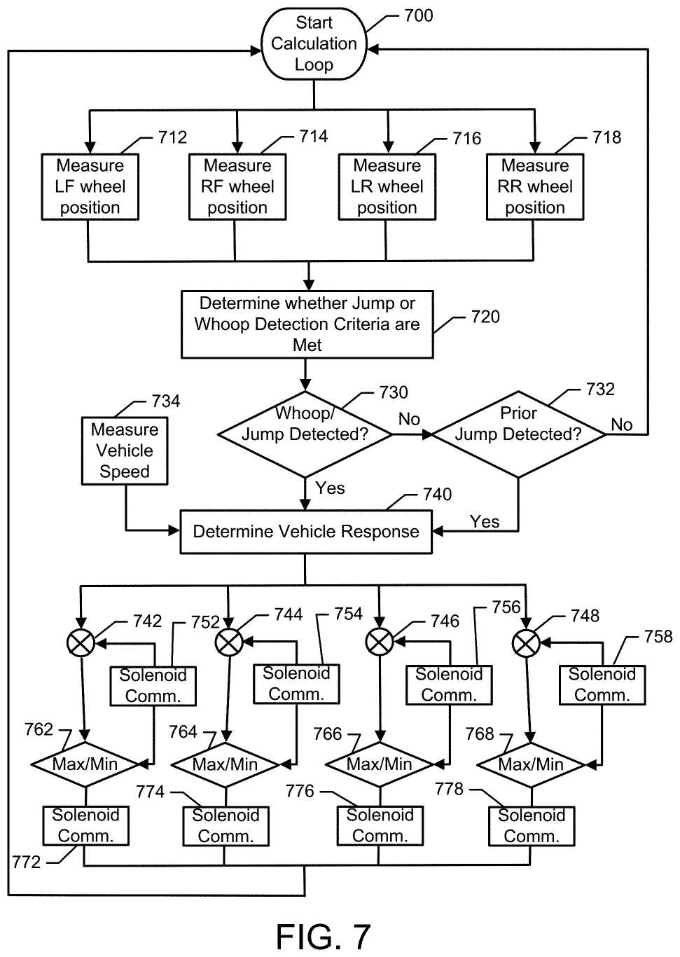

FIG. 7 illustrates a block diagram of a calculation loop that may be used by the controller 230 in accordance with an example embodiment. In this regard, as shown at operation 700, a calculation loop may be started. The calculation loop of some embodiments may have a duration of about 2 msec. However, other loop durations could be used in alternative embodiments. The loop itself may include measurement or determination of each individual wheel position. Thus, for example, operation 712 includes measuring left front wheel position, operation 714 includes measuring right front wheel position, operation 716 includes measuring left rear wheel position, and operation 718 includes measuring right rear wheel position.

At operation 720, a determination may be made as to whether jump detection criteria or whoop detection criteria are met. Jump detection criteria may include detection that a position of maximum rebound is reached for a period of time. As noted above, a timer may be started as soon as the position of maximum rebound is reached, and the timer may measure the amount of time that corresponding wheel or wheels are not in contact with the ground. The time period where there is no contact with the ground may be considered to be a hang time in some cases. Whoop detection criteria may include detection of repetitive or cyclic changes between compression and rebound. The cycles and changes need not be symmetric or exactly regular in their characteristics. However, a threshold may be defined for periodicity ranges and/or magnitude changes that are sufficient to be classified as cyclic and therefore classified as a whoop event.

If a whoop or jump is not detected at operation 730, then a determination may be made as to whether a previous jump was detected at operation 732. If not previous jump was detected, then the calculation loop may continue due to return to operation 700. However, if a jump was previously detected, then the vehicle may still be in a hang time period and flow follows the same route as if a whoop or jump is detected at operation 730. In this regard, if a whoop or jump is detected at operation 730 (or if a prior jump was detected at operation 732), then a vehicle response may be calculated at operation 740. The vehicle response may be determined in further consideration of the provision of vehicle speed information at operation 734.

The vehicle response that is calculated or determined at operation 740 may include any of the factors discussed above, and may be tuned over time. In other words, in addition to the programmed responses noted above, the controller 230 may also be capable of learning in real time and adapting the magnitude or timing of force instructions provided based on the results of previous operations. Factors that may be considered in relation to determining the vehicle response may include front and rear balance settings, vehicle speed sensitivity, and whoop vs. jump determination criteria. In some embodiments, a force table (e.g., lookup table 330) may be plotted versus vehicle speed and air time. The force table may be modified based on adaptive learning to adjust for under-performance or over-performance as determined by performance criteria that may also be stored by the controller 230 for self-evaluation and learning-based modification of the force tables.

Based on the vehicle response determined at operation 740, a comparison may be made at operations 742, 744, 746 and 748 to a front jounce solenoid command 752, a front rebound solenoid command 754, a rear jounce solenoid command 756 and a rear rebound solenoid command 758, respectively. These comparisons are then measured against any applicable maximum or minimum value limits (at operations 762, 764, 766 and 768, respectively) to determine new and updated command values (e.g., new front jounce solenoid command 772, new front rebound solenoid command 774, new rear jounce solenoid command 776 and new rear rebound solenoid command 778, respectively). In other words, the controller 230 operates the rebound solenoid 344 and the jounce solenoid 354 based on a comparison of a current solenoid position to a calculated solenoid position in consideration of any applicable maximum or minimum values associated with each one. In some cases, the solenoid commands may define control current or voltage values for application to the rebound solenoid 344 and/or jounce solenoid 354 as described above. The control flow may then return to operation 700 for another cycle of the loop calculation.

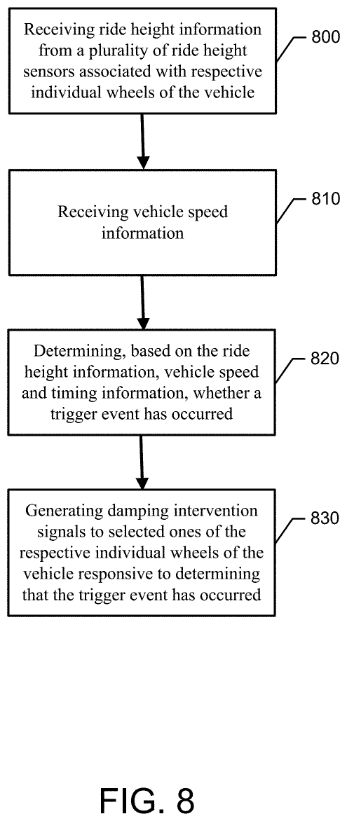

In an example embodiment, a method of automatically applying damping force interventions for a suspension system of a vehicle may be provided. An example of such a method is shown in the block diagram of FIG. 8. In this regard, the method may include receiving ride height information from a plurality of ride height sensors associated with respective individual wheels of the vehicle at operation 800, and receiving vehicle speed information at operation 810. The method may further include determining, based on the ride height information, vehicle speed and timing information, whether a trigger event has occurred at operation 820. The method may also include generating damping intervention signals to selected ones of the respective individual wheels of the vehicle responsive to determining that the trigger event has occurred at operation 830.

The method of some embodiments may include additional steps, modifications, augmentations and/or the like to achieve further objectives or enhance performance of the method. The additional steps, modifications, augmentations and/or the like may be added in any combination with each other. Below is a list of various additional steps, modifications, and augmentations that can each be added individually or in any combination with each other. For example, receiving the ride height information may include receiving an indication of wheel position of a corresponding one of the individual wheels relative to a range of travel between a maximum compression position and a maximum rebound position. Generating the damping intervention signals may include determining an amount of damping force and type of damping force (e.g., rebound damping or compression damping) to apply based on proximity of the wheel position of the corresponding one of the individual wheels to the maximum compression position or the maximum rebound position. In an example embodiment, generating the damping intervention signals may include simultaneously providing a rebound damping intervention and a compression damping intervention to the corresponding one of the individual wheels based on proximity of the wheel position of the at least one of the individual wheels to the maximum rebound position. In some examples, generating the damping intervention signals may include generating responsive damping intervention signals and anticipatory damping intervention signals in response to detecting the trigger event. In an example embodiment, the trigger event may be a jump event determined based on instantaneous wheel position measurement or a determination that the vehicle is driving over a series of whoops based on a durative indication of repetitive wheel position changes.

Example embodiments may provide improved suspension performance while driving over whoops to provide improved comfort and a greater enjoyment in the feel of the ride. Example embodiments may also provide improved yaw stability and avoidance of coming into proximity of conditions where pitch resonance may be reached. In this regard, example embodiments may provide a vehicle control system. The vehicle control system may include a plurality of ride height sensors that determine ride height information associated with individual wheels of a vehicle, a plurality of adjustable dampers associated with respective ones of the individual wheels of the vehicle, and a controller that detects a trigger event and generates damping intervention signals to change damping force applied by selected ones of the adjustable dampers based on vehicle speed, the ride height information, and timing information corresponding to the selected ones of the adjustable dampers in response to detecting the trigger event.

The system of some embodiments may include additional features, modifications, augmentations and/or the like to achieve further objectives or enhance performance of the system. The additional features, modifications, augmentations and/or the like may be added in any combination with each other. Below is a list of various additional features, modifications, and augmentations that can each be added individually or in any combination with each other. For example, the ride height information may include an indication of wheel position of a corresponding one of the individual wheels relative to a range of travel between a maximum compression position and a maximum rebound position. In an example embodiment, the controller may simultaneously provide a rebound damping intervention and a compression damping intervention to at least one of the individual wheels based on proximity of the wheel position of the at least one of the individual wheels to the maximum rebound position. In some cases, the trigger event is a jump event, and the controller detects the jump event based on an indication of a wheel having a wheel position at the maximum rebound position. In an example embodiment, the controller may increase an amount of compression damping to apply to a selected one of the adjustable dampers associated with the wheel as time at the maximum rebound position increases. In some examples, the controller may generate responsive damping intervention signals and anticipatory damping intervention signals in response to detecting the trigger event. In an example embodiment, the controller may utilize a lookup table defining damping force values based on the vehicle speed, the ride height information, and the timing information. In an example embodiment, the controller may adjust the lookup table over time based on learning associated with an evaluation of past performance of the controller in relation to determining the damping intervention signals. In an example embodiment, the controller may provide the damping intervention signals to a rebound solenoid of the adjustable damper and to a compression solenoid of the adjustable damper to change the force. In some cases, the trigger event may be a jump event determined based on instantaneous wheel position measurement. In an example embodiment, the trigger event may be a determination that the vehicle is driving over a series of whoops based on a durative indication of repetitive wheel position changes. In some cases, the controller may be configured to apply a gain factor to the damping intervention signals based on the vehicle speed. In an example embodiment, each of the adjustable dampers may include a rebound solenoid operable to adjust rebound damping force, and a compression solenoid operable to adjust compression damping force. In some cases, the rebound solenoid and the compression solenoid may each be controlled based on a comparison of a current solenoid position to a calculated solenoid position in consideration of applicable maximum or minimum values.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A vehicle control system comprising:
a plurality of ride height sensors that determine ride height information associated with individual wheels of a vehicle;
a plurality of adjustable dampers associated with respective ones of the individual wheels of the vehicle; and
a controller that detects a trigger event and generates damping intervention signals to change damping force applied by selected ones of the adjustable dampers based on vehicle speed, the ride height information, and timing information corresponding to the selected ones of the adjustable dampers in response to detecting the trigger event.

2. The system of claim 1, wherein the ride height information comprises an indication of a wheel position of a corresponding one of the individual wheels relative to a range of travel between a maximum compression position and a maximum rebound position.

3. The system of claim 2, wherein the controller simultaneously provides a rebound damping intervention and a compression damping intervention to at least one of the individual wheels based on proximity of the wheel position of the at least one of the individual wheels to the maximum rebound position.

4. The system of claim 2, wherein the trigger event is a jump event, and wherein the controller detects the jump event based on an indication of a wheel having the wheel position at the maximum rebound position.

5. The system of claim 4, wherein the controller increases an amount of compression damping to apply to a selected one of the adjustable dampers associated with the wheel as time at the maximum rebound position increases.

6. The system of claim 1, wherein the controller generates responsive damping intervention signals and anticipatory damping intervention signals in response to detecting the trigger event.

7. The system of claim 1, wherein the controller utilizes a lookup table defining damping force values based on the vehicle speed, the ride height information, wheel velocity, and the timing information.

8. The system of claim 7, wherein the controller adjusts the lookup table over time based on learning associated with an evaluation of past performance of the controller in relation to determining the damping intervention signals.

9. The system of claim 7, wherein the controller provides the damping intervention signals to a rebound solenoid of the adjustable damper and to a compression solenoid of the adjustable damper to change the force.

10. The system of claim 1, wherein the trigger event is a jump event determined based on instantaneous wheel position measurement.

11. The system of claim 1, wherein the trigger event is a determination that the vehicle is driving over a series of whoops based on a durative indication of repetitive wheel position changes.

12. The system of claim 1, wherein the controller is configured to apply a gain factor to the damping intervention signals based on the vehicle speed.

13. The system of claim 1, wherein each of the adjustable dampers comprises a rebound solenoid operable to increase rebound damping force, and a compression solenoid operable to increase compression damping force.

14. The system of claim 13, wherein the rebound solenoid and the compression solenoid are each controlled based on a comparison of a current solenoid position to a calculated solenoid position in consideration of applicable maximum or minimum values.

15. A method of automatically applying damping force interventions for a suspension system of a vehicle, the method comprising:
receiving ride height information from a plurality of ride height sensors associated with respective individual wheels of the vehicle;
receiving vehicle speed information;
determining, based on the ride height information, vehicle speed and timing information, whether a trigger event has occurred; and
generating damping intervention signals to selected ones of the respective individual wheels of the vehicle responsive to determining that the trigger event has occurred.

16. The method of claim 15, wherein receiving the ride height information comprises receiving an indication of wheel position of a corresponding one of the individual wheels relative to a range of travel between a maximum compression position and a maximum rebound position, and
wherein generating the damping intervention signals comprises determining an amount of damping force and type of damping force to apply based on proximity of the wheel position of the corresponding one of the individual wheels to the maximum compression position or the maximum rebound position.

17. The method of claim 16, wherein generating the damping intervention signals comprises simultaneously providing a rebound damping intervention and a compression damping intervention to the corresponding one of the individual wheels based on proximity of the wheel position of the at least one of the individual wheels to the maximum rebound position.

18. The method of claim 15, wherein generating the damping intervention signals comprises generating responsive damping intervention signals and anticipatory damping intervention signals in response to detecting the trigger event.

19. The method of claim 15, wherein the trigger event is a jump event determined based on instantaneous wheel position measurement.

20. The method of claim 15, wherein the trigger event is a determination that the vehicle is driving over a series of whoops based on a durative indication of repetitive wheel position changes.
